(19) United States
(12) Patent Application Publication
(10) Pub. No.: US 2005/0186050 A1
(43) Pub. Date: Aug. 25, 2005

(54) Hydraulic nut assembly

(75) Inventors: Gordon Britton, Grand Bend (CA); David Hughes, Grand Bend (CA); Mark Johnson, Dallas, TX (US)

Correspondence Address: Timothy E. Nauman;Fay, Sharpe, Fagan, Minnich & McKee, LLP, 7th Floor, 1100 Superior Avenue, Cleveland, OH, 44114-2518, US

(73) Assignee: Integra Technologies Limited

(21) Appl. No.: 10/886,959

(22) Filed: Jul. 8, 2004

(30) Foreign Application Priority Data
Feb. 19, 2004 (CA) 2,457,968

(51) Int. Cl. F16B 37/08

(52) U.S. Cl. 411/434

(57) ABSTRACT

A hydraulic nut for tensioning an assembly includes a mechanical threaded locking collar to minimize load loss during transfer of hydraulic load to the locking collar, a Z shaped annual piston to minimize height of the hydraulic nut, an annular pressure area to generate an axial load under hydraulic pressure, a hydraulic pressure port and metallic seals to maintain the hydraulic pressure within the annular pressure area that operates in an elastic region and continues to actuate hydraulic pressure after repeated operating temperature cycles.

### FIELD OF THE INVENTION

The present invention generally relates to a hydraulic nut assembly. More specifically, the present invention is concerned with a hydraulic nut which provide a load to a fastener in an assembly.

### BACKGROUND OF THE INVENTION

Hydraulic nuts are well known and have been in wide use throughout the industry for many decades.

More recently, hydraulic nuts are made up of an inner body that is threaded on to the stud to be tightened, an outer body that acts as a piston to generate an axial load to clamp the work pieces being joined and a locking collar to mechanically maintain the axial load generated by the hydraulic pressure in the annual piston created between the inner and outer bodies. The gap between the inner and outer bodies needs to be sealed so that hydraulic pressure is generated. This is achieved by a built-in or added sealing device.

Assembly of thousands of bolted flanged connections occurs annually throughout the resource processing industries of oil and gas, power generation and other manufacturing industries. General assembly technologies primarily include hand or hammer tightening and some torque tightening. Problems remain with these general tightening processes that result in failure of the clamped connection, delays and work place injuries.

Hydraulic nuts have been seen to address these concerns. However, present forms of hydraulic nuts limits their use on a variety of applications.

Some of the limitations of present hydraulic nut technology concern the space envelope required to fit the nut, reliable assembly and disassembly of the nut after repeated operating cycles at temperature and the speed to install the nuts.

The aim of this invention is to broaden the use of hydraulic nut technology so that a wider number of applications can realize its benefits.

### SUMMARY OF THE INVENTION

More specifically, in accordance with the present invention, there is provided a hydraulic nut for tensioning an assembly including an inner body, an outer body matingly connected to the inner body, a locking collar adapted to be mounted on the inner body and located adjacent to the outer body, a sealing means located between the inner body and the outer body, an annular pressure area defined between the inner body, the outer body and the sealing means, the hydraulic nut also including a hydraulic pressure port extending through the hydraulic nut to the pressure area.

Other objects, advantages and features of the present invention will become more apparent upon reading of the following non-restrictive description of preferred embodiments thereof, given by way of example only with reference to the accompanying drawings.

### BRIEF DESCRIPTION OF THE FIGURES

In the appended drawings:

FIG. 1 is a side elevation view showing a hydraulic nut assembly according to an embodiment of the present invention;

FIG. 2a is a partial section view showing the z-shaped piston of the hydraulic nut assembly of FIG. 1;

FIG. 2b is a partial section view showing a hydraulic nut assembly from the prior art;

FIG. 3 is a partial detail view showing the threads of the hydraulic nut assembly of FIG. 1;

FIG. 4a is a partial detail view showing the seal of a hydraulic nut assembly from the prior art;

FIG. 4b is a partial detail view showing the seal of a hydraulic nut assembly from the prior art;

FIG. 5 is a partial detail view showing the seal of the hydraulic nut assembly of FIG. 1;

FIG. 6 is a partial detail view showing a misalignment of the seal of FIG. 5;

FIG. 7 is a partial detail view showing the elastic movement of the seal of FIG. 5;

FIG. 8 is a partial detail view showing the retaining lip of the hydraulic nut assembly of FIG. 1;

FIG. 9a is a top view showing the uneven number of tommy bars holes in the collar of the hydraulic nut assembly of FIG. 1;

FIG. 9b is a side elevation view showing the uneven number of tommy bars of the collar of FIG. 9a;

FIG. 10a is a top view showing the dowel holes of the hydraulic nut of FIG. 1;

FIG. 10b is a section view showing the dowel holes of FIG. 10a;

FIG. 11a is a top view showing the nut turning device of the hydraulic nut assembly of FIG. 1;

FIG. 11b is a section view taken along line A-A of FIG. 11a;

FIG. 11c is a section view taken along line B-B of FIG. 11a;

FIG. 12 is a top view showing the nut turning nipper of the hydraulic nut assembly of FIG. 1;

FIG. 13 is a partial detail view showing the deflection of the tapered wall of the hydraulic nut of FIG. 1;

### DETAILED DESCRIPTION

Generally stated, the present invention relates to hydraulic nuts which may be used to provide a load to a fastener in an assembly.

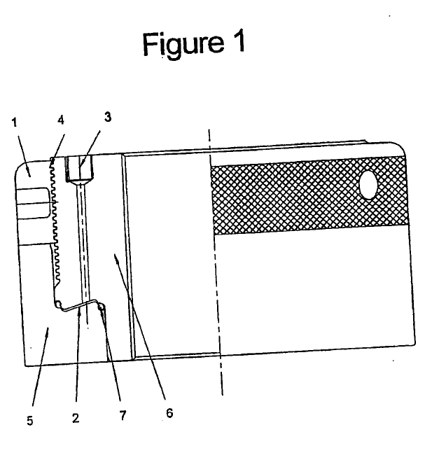

As shown in FIG. 1, a hydraulic nut generally includes an inner body (6) that is threaded on to the stud (not shown) to be tightened, an outer body (5) that acts as a piston to generate an axial load to clamp the work pieces being joined and a locking collar (1) to mechanically maintain the axial load generated by the hydraulic pressure in the annual piston created between the inner and outer bodies. The gap between the inner and outer bodies generally needs to be sealed so that hydraulic pressure is generated. This is achieved by a built-in or added sealing device.

The present invention concerns the following aspects of a hydraulic nut assembly:

“Z” Shaped Piston

As seen in FIG. 1, pressure is generated in the annular piston area (2) created between the sealing devices (7) of the inner and outer nut bodies (6 and 5).

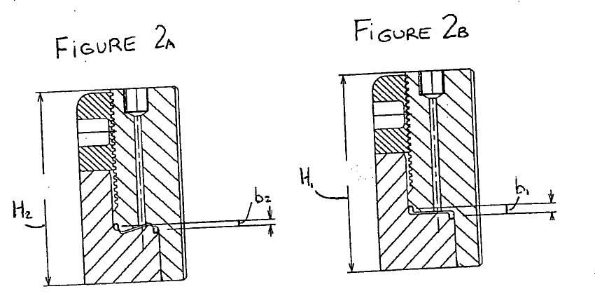

By staggering the seal arrangement as shown in FIG. 2a when compared to a prior art hydraulic nut illustrated in FIG. 2b, the overall height of the nut can be reduced according to the following equation:
H₂=H₁−(b₁−b₂)
where:
H₂ is height of the hydraulic nut assembly;
H₁ is height of a hydraulic nut of the prior art;
b₁ is axial distance between seals of a hydraulic nut of the prior art; and
b₂ is axial distance between seals of the hydraulic nut assembly.
   Low Load Loss Locking Collar

While under pressure, an axial load is generated in the hydraulic nut tensioning the stud or fastener in an equal axial direction while compressing the components in the work piece.

In many hydraulic nut applications, a mechanical locking collar is utilized to retain the load generated by the hydraulic pressure. This is achieved by turning down the locking collar (1) while under hydraulic pressure, using the mating threads (4) between the locking collar and inner body (6), until the face of the locking collar (1) is in firm contact with the mating face of the outer body. The hydraulic pressure is then released. A transfer of load then occurs between the mating threads of the locking collar and inner body and the mating face between the locking collar and outer body. The threads of the locking collar and inner body will tend to deflect under the applied load. The angle of the threads cause a radial force exerted by the threads causing a radial deflection of the locking collar. The radial deflection of the locking collar allows the collar to slide down the inclined plane of the thread form. The result of the thread deflection and thread sliding is to cause a loss of preload generated by the hydraulic pressure. In order to maintain the required load, higher applied pressures are required to achieve the necessary residual load. A load loss is created due to the thread form and transfer of load. This load loss has to be accounted for in the nut design by designing a nut with higher applied load. This increases the annular piston area and resultant increase in nut dimensions.

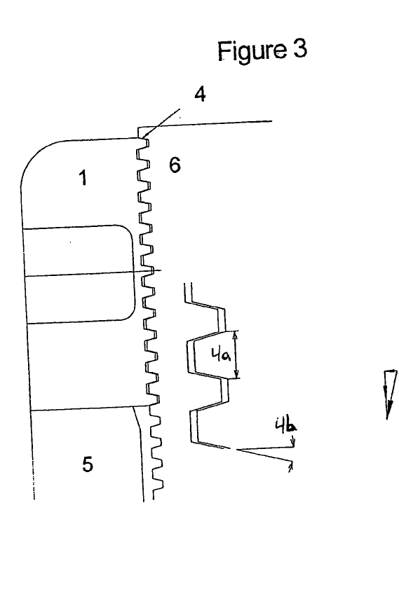

The hydraulic nut assembly of the present invention utilizes a thread with a broader cross-section such as a stub acme thread which is outlined in FIG. 3.

The stub acme thread (4) has a broad cross section (4a) as compared to standard thread forms, the increased moment of inertia and low moment arm of the reaction force generally results in low thread deflection under applied load. The load loss is therefore reduced, reducing the annular piston area and over dimensions of the nut making it more compact and able to fit in to a broader number of applications.

The shallow angle (4b) of the threads also reduces the radial force generated when the load is transferred to the locking collar. This also generally reduces the hoop stress in the locking collar.

High Performance Metallic Seal

As seen in FIG. 1, the hydraulic nut is generally pressured through a hydraulic port (3). The pressure is applied across the surfaces of the annular piston (2) generating an applied load in proportion to the hydraulic pressure and hydraulic area. The pressure is held between seals (7) that seal off the radial gap between the nut inner (6) and outer bodies (5).

Traditional hydraulic nut seals are typically made from elastomeric material. Elastomers have limits on operating temperatures and pressures that make them ineffective in high temperature applications or restricted work space applications that need a more compact nut that operates at higher pressures. Newer metallic seals have been developed to overcome some of the limitations.

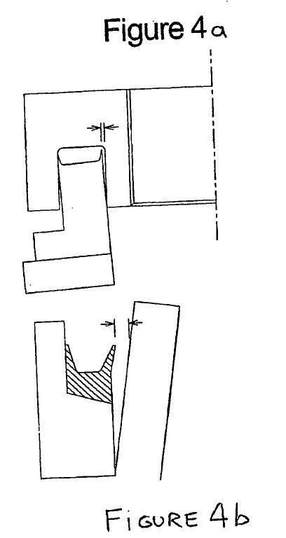

Common metallic seals in use now are uni-body featheredged seals (FIG. 4a). These seals are a machined lip that is part of the body of the hydraulic nut (FIG. 4b), or machined as a separate component (FIG. 4b). A thin lip comes in contact with the cylinder wall under pressure to maintain a seal. While this seal can be effective at high hydraulic pressures, it often leaks at low pressures when it does not have the advantage of the force of the hydraulic pressure to contact the cylinder. Integral and machined edge seals have low elastic resistance. In service, misalignment of the components of the nuts is a common occurrence due to misalignment of the stud and the flange it is connected to. This misalignment causes the sealing to pull away from the cylinder wall, resulting in leakage. Under pressure, the cylinder wall deflects (FIGS. 4a and 4b) outward in a radial direction. The seal must move outward with the wall to maintain contact and seal. The limitations of the existing metallic seals to maintain hydraulic pressure at low pressure during service misalignment and cylinder wall deflection limits their use.

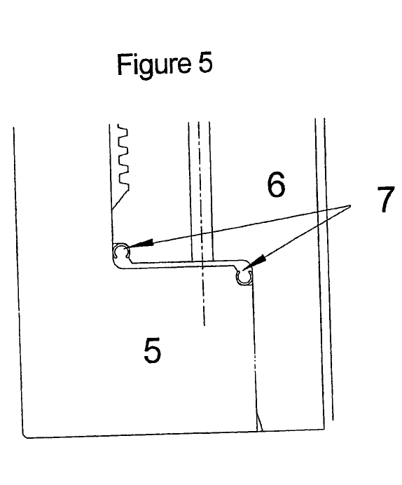

The hydraulic nut assembly generally includes a thin-walled curved ‘U’ seal as shown in FIG. 5. The thin walled (approximately 0.015″) ‘U’ seal has excellent elastic capability and can accommodate far greater radial movement than the edged seals. The ‘U’ seal may be installed with a slight interference fit. Its flexibility generally allows easy installation, with reduced friction during movement. The interference fit generally maximizes contact with the cylinder walls at lower pressures as well as extreme high pressures.

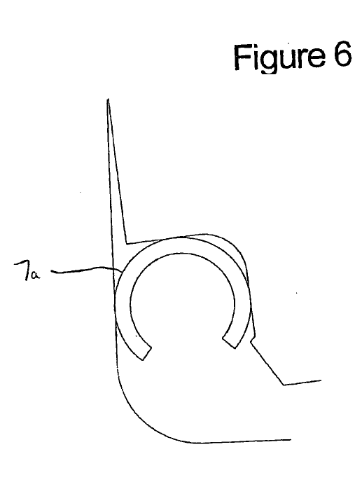

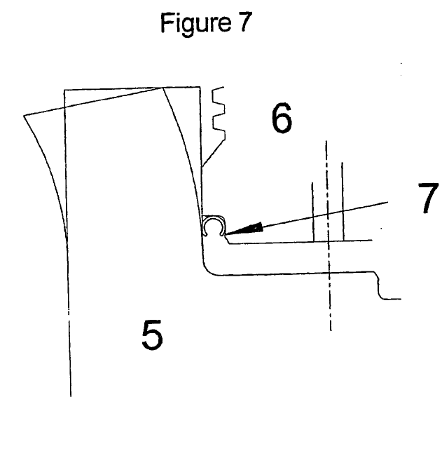

The seal contact is made on a curved surface of the ‘U’ seal (FIG. 6). The curved seal surface 7a maintains contact during misalignment. The curved ‘U’ shaped seal acts as an open thin walled cylinder. Pressure acting on the side of the seal deflects the seal in a radial direction. The supported thin wall section allows for enhanced elastic range for the seal to move with radial expansion of the cylinder (5, FIG. 7).

Seal Retaining Lip

A hydraulic nut generally operates with the inner and outer body moving in an axial direction under pressure. The seal needs to be fixed to one component while it slides along the cylinder wall of the outer component. If the seal moves out of its groove on the fixed component, hydraulic fluid will leak around it.

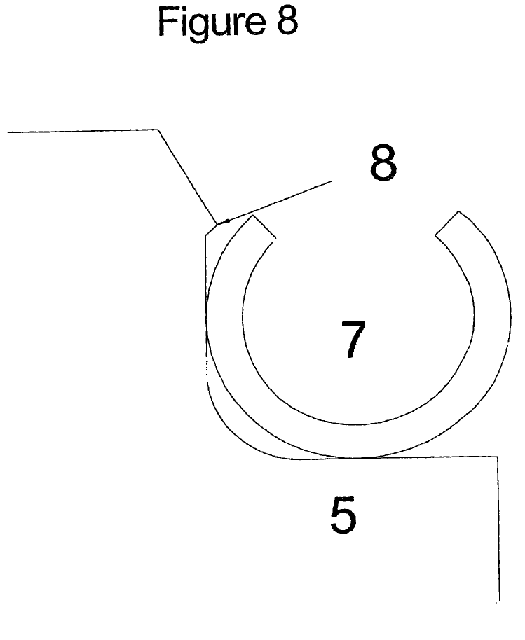

A retain lip (8 in FIG. 8) may be machined into the nut bodies (5) and (6) to help retain the seal (7) in place. The curved ‘U’ shape seal (7) generally has sufficient elastic flexibility to be inserted into the groove of the hydraulic nut and ‘snap’ into place. The lip (8) then generally prevents the seal from moving in an axial direction under hydraulic operation in the fixed component while it maintains a sliding contact on the cylinder wall of the moving component. The retaining lip (8) may be machined into both the inner and outer bodies (5) and (6) to retain these seals (7) respectively.

Uneven Tommy Bar Holes

Locking collars traditionally have tommy bars holes machined radially into the wall of the locking collar. These holes reduce the cross-section of the locking at point, thereby weakening the component. Often, tommy bar holes are machined in even numbers around the locking collar, such that on any given axis, there are two holes opposing each other. This further weakens the locking collar on these axes.

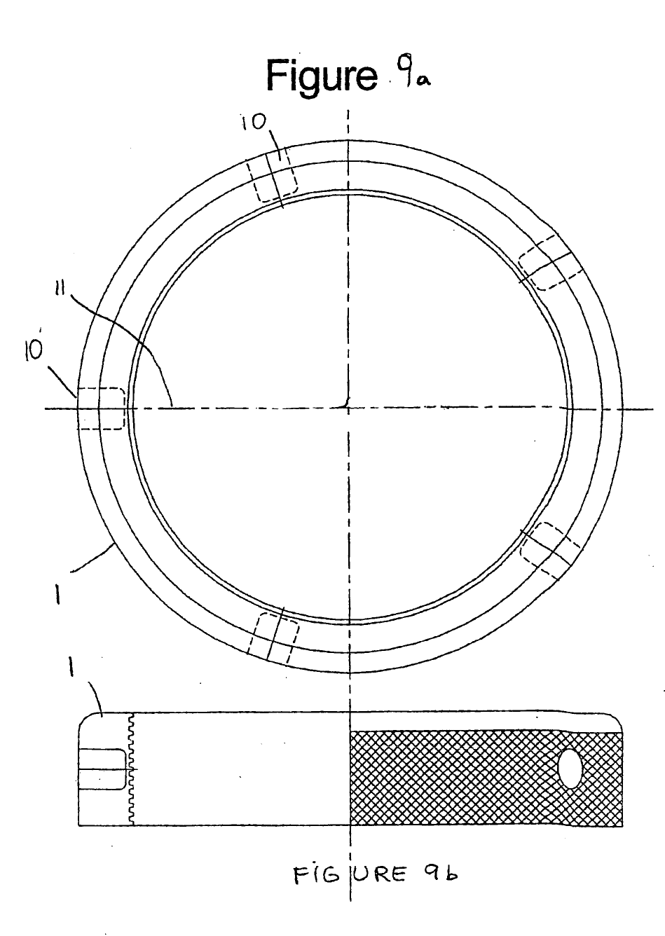

As seen in FIGS. 9a and 9b, the hydraulic nut assembly generally incorporates an odd number of tommy bar holes (10) such that on the axis (11) of one hole (10), there is not an opposing tommy bar hole (10) that would further weaken the locking collar (1).

Nut Installation Dowel Holes

Hydraulic nuts are generally round and are turned onto the stud by hand. In some applications tommy bar holes may be drilled in the body of the nut in a radial direction to allow insertion of a tommy to assist in turning the nut on to or off the stud. On larger studs, it can be a slow and awkward process to thread the hydraulic nut on to the stud. It is also difficult to generate a significant turning torque on a round nut to overcome stud thread to nut thread friction. This can hamper and prevent successful removal of the nut that has been in service for some time. Problems such as these impair the successful use of hydraulic nuts.

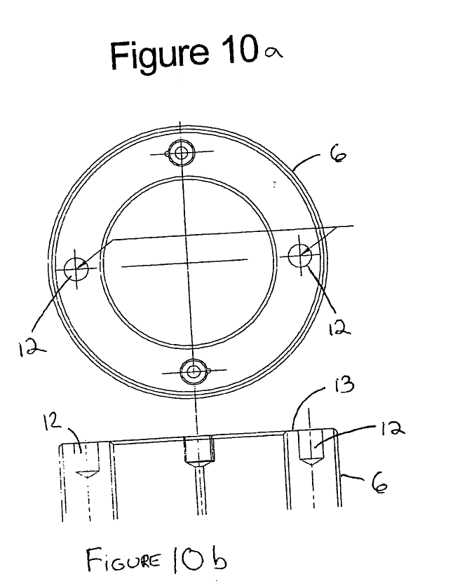

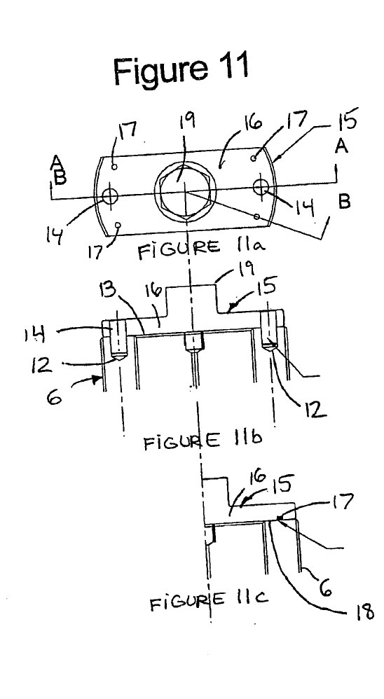

The hydraulic nut assembly may include dowel holes (12 in FIGS. 10a and 10b) machined in the end face (13) of the inner body (6) of the hydraulic nut to facilitate the insertion of a special nut turning device. The dowel holes (12) and mating dowels (shown in FIGS. 11a and 11b) are suitably sized to withstand the torque required to install the nuts rapidly and to remove the nuts, generally overcoming corrosion and increased friction associated with a nut that has been in service for some time.

Rapid Nut Turning Device

The hydraulic nut assembly may include a rapid nut turning device (15 in FIGS. 11a, 11b and 11c) generally consisting of a rigid plate (16) with dowels (14) suitably posited and sized to fit into the dowel holes (12) which may be present in the nut body (6) as outlined hereinabove.

To aid in the handling and connection of the turning device (15) to the nut, magnets (17) may be mounted on the underside (18) of the turning device (15) to support it onto a magnetic nut during its turning. The nut turning device (15) may contain a drive (19) to support or allow a connection to an external tool or power source in order to help supply sufficient torque to turn the hydraulic nut on to the stud.

Thread Corrosion Protection

After the nut has been put into service, corrosion usually result in seizing critical components of the hydraulic nut, preventing a fast and easy disassembly. This problem relates to the inability to loosen the locking collar using the tommy bar due to corrosion of the mating threads of the locking collar and inner body.

Concern also exists relative to the possibility for corrosion to seize the internal threads of the hydraulic nut to its mating stud, preventing an easy removal of a round nut.

The hydraulic nut assembly may also include an anti-corrosive coating on the locking collar (1) and the inner body (6), such that all mating threads are coated to maximize the resistance to in-service corrosion.

Nut Turning Nipper

As described hereinabove, round hydraulic nuts can be cumbersome to install on studs and there is a concern over corrosion and seizing of the nut. Traditional round nuts can be difficult to turn on and off a stud.

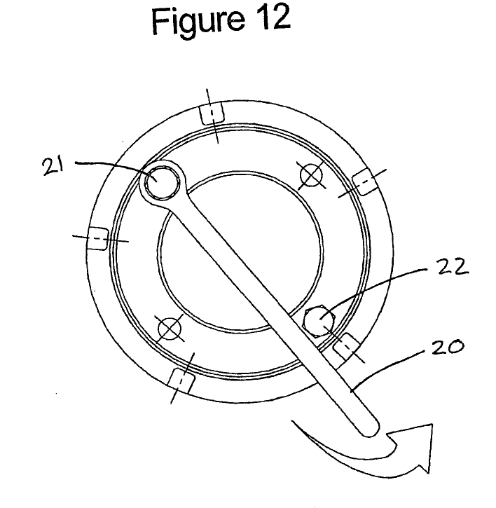

A nut turning spanner (20 in FIG. 12) may be inserted over the hydraulic nipple or plug 21 on the end force of the nut, and using the second nipple or plug 22 on the opposite side of the nut as a reaction point, a clockwise or counter-clockwise movement of the nut turning spanner will easily thread on or thread off the hydraulic nut, which also helps overcome any corrosion bond between the hydraulic nut and its mating stud.

Tapered Inner Wall

Under high hydraulic pressures, the cylinder wall may deflect outwardly in a radial direction, as explained hereinabove. As the outer body moves in the axial direction, during the stroke operation, the increased stroke tends to also increase the wall deflection. The seal must move outward with the wall to maintain contact and seal. In certain applications, limits may be imposed on the seal performance due to excessive wall deflection.

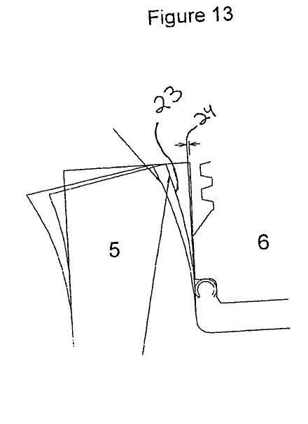

As illustrated in FIG. 13, a tapered wall generally offsets some of the wall (23) deflection that may occur during high pressure and high stroke. The wall (23) of the outer body (5) may be machined with a slight taper (24) in the inside cylinder, such that the inner diameter of the cylinder at the top is slightly smaller than the inside diameter at the bottom, by an amount which is generally similar to the radial deflection experienced by the nut during pressurization.

Although the present invention has been described hereinabove by way of preferred embodiments thereof, it can be modified, without departing from the spirit and nature of the subject invention as defined in the appended claims.

1. A hydraulic nut for tensioning an assembly comprising:
a) an inner body;
b) an outer body matingly connected with said inner body;
c) a locking collar adapted to be mounted on said inner body and located adjacent to said outer body;
d) a sealing means located between said inner body and said outer body;
e) an annular pressure area defined between said inner body, said outer body and said sealing means; and
f) a hydraulic pressure port extending through said hydraulic nut to said pressure area.
